(19) United States
(12) Patent Application Publication
(10) Pub. No.: US 2024/0411577 A1
(43) Pub. Date: Dec. 12, 2024

(54) UNIFIED DATA STREAMING FRAMEWORK IN VIRTUALIZATION MANAGEMENT SOFTWARE

(71) Applicant: VMware, Inc., Palo Alto, CA (US)

(72) Inventors: Syed ANWAR, Bangalore (IN); Kundan SINHA, Bangalore (IN); Georgi Lyubomirov DIMITROV, Plovdiv (BG); Shalini KRISHNA, Bangalore (IN); Kiril KARAATANASSOV, Sofia (BG)

(21) Appl. No.: 18/331,050

(22) Filed: Jun. 7, 2023

(51) Int. Cl. G06F 9/455

(52) U.S. Cl. CPC G06F 9/45558; G06F 2009/45579

(57) ABSTRACT

An example method of accessing object data managed by virtual infrastructure (VI) services of virtualization management software that manages a cluster of hosts in a data center and a virtualization layer executing in the cluster of hosts includes: receiving, from a client at a unified data service executing in the virtualization management software, a request for accessing the object data; planning, in response to the request, an operation to access the object data that targets a first VI service of the VI services; invoking, in response to the operation, an application programming interface (API) of the first VI service to access the object data, the API being exposed by a unified data library integrated with the first VI service; and forwarding, from the unified data service to the client, a result of accessing the object data.

### BACKGROUND

In a software-defined data center (SDDC), virtual infrastructure, which includes virtual compute, storage, and networking resources, is provisioned from hardware infrastructure that includes a plurality of host computers, storage devices, and networking devices. The provisioning of the virtual infrastructure is carried out by virtualization management software that communicates with virtualization software (e.g., hypervisor) installed in the host computers.

Virtualization management software can have a distributed architecture with multiple services exposing many endpoints (e.g., application programming interfaces (APIs)). This translates to many data objects with many data sources. A client may be required to fetch data objects from the virtualization management software, including tracking incremental updates to the data objects over time. This requires the client to integrate with X number of services times Y number of resources per service times Z number of APIs (operations) (where X, Y, and Z are positive integers). There is a need for a more efficient and scalable solution to fetch and apply changes to data managed by virtualization management software in a data center.

### SUMMARY

In an embodiment, a method of accessing object data managed by virtual infrastructure (VI) services of virtualization management software that manages a cluster of hosts in a data center and a virtualization layer executing in the cluster of hosts is described. The method includes: receiving, from a client at a unified data service executing in the virtualization management software, a request for accessing the object data; planning, in response to the request, an operation to access the object data that targets a first VI service of the VI services; invoking, in response to the operation, an application programming interface (API) of the first VI service to access the object data, the API being exposed by a unified data library integrated with the first VI service; and forwarding. from the unified data service to the client, a result of accessing the object data.

Further embodiments include a non-transitory computer-readable storage medium comprising instructions that cause a computer system to carry out the above method, as well as a computer system configured to carry out the above method.

### BRIEF DESCRIPTION OF THE DRAWINGS

FIG. 1A is a block diagram of an on-premises environment that is managed through a cloud platform implemented in a public cloud according to embodiments.

FIG. 1B is a block diagram depicting a host on which a VIM appliance can execute according to embodiments.

FIG. 2 is a block diagram depicting a unified data framework executing in a VIM appliance according to embodiments.

FIG. 3 is a block diagram depicting integration of a unified data library with a VI service according to embodiments.

FIG. 4 is a flow diagram depicting a method of fetching a snapshot of object data by a client from a unified data framework according to an embodiment.

FIG. 5 is a flow diagram depicting a method of handling a fetch operation at a VI service according to an embodiment.

FIG. 6 is a flow diagram depicting a method of subscribing to a stream of data object updates by a client to unified data service according to embodiments.

FIG. 7 is a flow diagram depicting a method of handling a streaming request at a VI service according to an embodiment.

FIG. 8 is a flow diagram depicting a method of applying a snapshot of object data by a client to a unified data framework according to an embodiment.

FIGS. 9A-9F depict dependency graphs and selected nodes for applying a snapshot of object data to be updated according to embodiments.

FIG. 10 is a flow diagram depicting a method of determining drift from a desired state at a client according to an embodiment.

### DETAILED DESCRIPTION

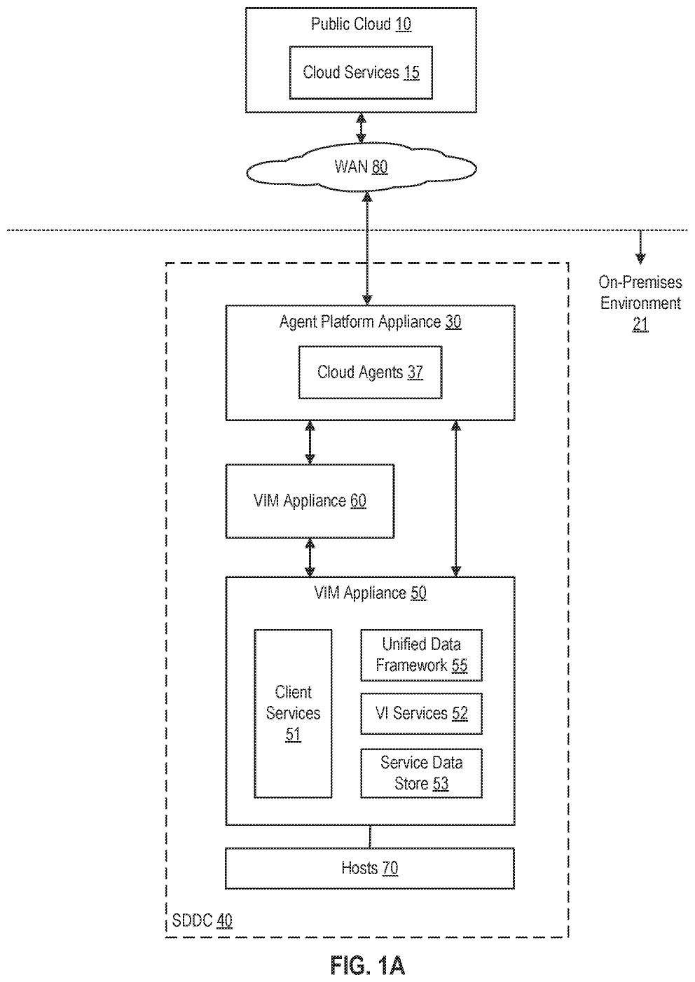

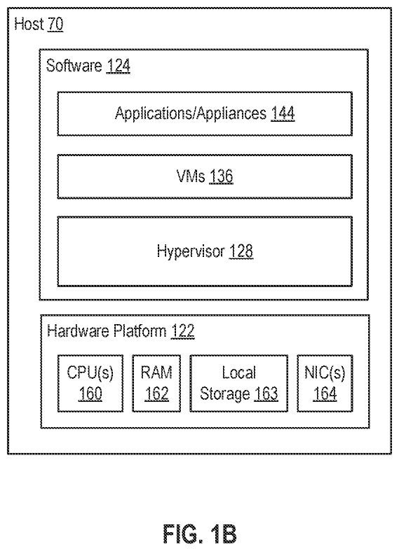

FIG. 1A is a block diagram of an on-premises environment 21 that is managed through cloud services 15 executing in a public cloud 10 according to embodiments. FIG. 1A shows an example deployment of virtualization management software and corresponding clients. The virtualization management software is implemented by a virtual infrastructure management (VIM) appliance 50. An appliance is an application (e.g., virtualization management software) deployed in a virtual machine (VM) or physical host. VIM appliance 50 is configured to manage virtualization of hosts 70 in an SDDC 40. VIM appliance 50 can execute on one or more of hosts 70. VIM appliance 50 includes virtual infrastructure (VI) services 52. Each VI service 52 is responsible for some virtualization management function. Example VI services 52 include a main daemon service, tagging service, resource scheduling service, and high-availability service among many others. VI services 52 store and update data objects in service data store 53. Service data store 53 comprises, for example, one or more databases. Data objects represent resources or items related to resources. Example data objects include clusters, hosts, VMs, datastores, virtual networks, tags, categories, and folders among many others.

Clients of VIM appliance 50 can fetch data objects and apply updates to data objects as discussed herein. Example clients of VIM appliance 50 include client services 51 executing on VIM appliance 50 itself (internal clients) and external clients. External clients include, for example, another VIM appliance 60 and cloud agents 37 executing in an agent platform appliance 30 among other external clients. VIM appliance 60 is configured to manage one or more other VIM appliances, including VIM appliance 50. Agent platform appliance 30 is configured to deliver cloud services 15 executing in a public cloud 10 to SDDC 40 executing in an on-premises environment 21 through a wide area network (WAN) 80, such as the public Internet. VIM appliance 60 and cloud agents 37 can fetch data objects from VIM appliance 50 and apply updates to such data objects. While a specific multi-cloud architecture is shown in FIG. 1A by example, it is to be understood that the techniques described herein involve one or more clients accessing data objects managed by virtualization management software, such as a VIM appliance. While FIG. 1A shows one example deployment of a VIM appliance 50 and its clients, those skilled in the art appreciate that there are many other types of deployments for virtualization management software and corresponding internal and/or external clients with which the techniques described herein can operate.

In embodiments, VIM appliance 50 includes a unified data framework 55. Clients fetch data objects and apply updates to such data objects through unified data framework 55 rather than invoking APIs of VI services 52 directly. Unified data framework 55 supports various requests by clients. In embodiments, clients can query for available data schemas, including support for predefined schema tags (e.g., a replication tag used to determine a set of data objects exposed for replication). Clients can fetch a snapshot of object data by providing a schema filter (e.g., using the replication tag to fetch data objects exposed for replication). Clients can request unified data framework 55 to stream updates to specific object data according to a schema filter. Streams can start from the beginning (e.g., all object data) or from a provided checkpoint (e.g., only object data modified after the checkpoint). Clients can request a snapshot of object data be applied to VI services 52 in order to update/modify object data.

FIG. 1B is a block diagram depicting a host 70 on which a VIM appliance 50 can execute according to embodiments. A hardware platform 122 of host 70 includes conventional components of a computing device, such as one or more central processing units (CPUs) 160, system memory (e.g., random access memory (RAM) 162), one or more network interface controllers (NICs) 164, and optionally local storage 163. CPUs 160 are configured to execute instructions, for example, executable instructions that perform one or more operations described herein, which may be stored in RAM 162. NICs 164 enable host 70 to communicate with other devices through a physical network.

Software 124 of each host 70 provides a virtualization layer, referred to herein as a hypervisor 128, which directly executes on hardware platform 122. In an embodiment, there is no intervening software, such as a host operating system (OS), between hypervisor 128 and hardware platform 122. Thus, hypervisor 128 is a Type-1 hypervisor (also known as a “bare-metal” hypervisor). As a result, hypervisors 128 is a bare-metal virtualization layer executing directly on hardware platform 122. Hypervisor 128 abstracts processor, memory, storage, and network resources of hardware platform 122 to provide a virtual machine execution space within which multiple virtual machines (VM) 136 may be concurrently instantiated and executed. Applications and/or appliances 144 execute in VMs 136, such as VIM appliance 50.

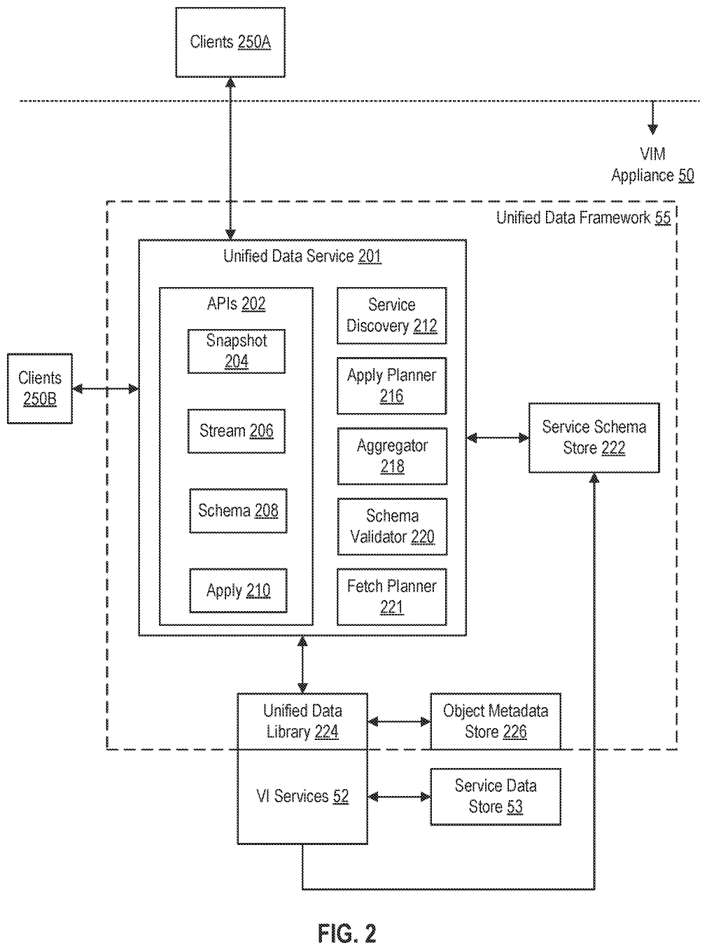

FIG. 2 is a block diagram depicting a unified data framework 55 executing in a VIM appliance 50 according to embodiments. Clients of unified data framework 55 include clients 250A external to VIM appliance 50 and/or clients 250B internal to VIM appliance 50 (examples shown in FIG. 1A). Unified data framework 55 includes unified data service 201, service schema store 222, unified data library 224, and object metadata store 226. VI services 52 store and update respective object data in service data store 53. Each VI service 52 is integrated with unified data library 224 as discussed further herein. Unified data service 201 includes APIs 202, service discovery logic (“service discovery 212”), apply planner logic (“apply planner 216”), aggregator logic (“aggregator 218”), schema validation logic (“schema validator”), and fetch planner logic (“fetch planner 221”). APIs 202 include snapshot APIs 204, stream APIs 206, schema APIs 208, and apply APIs 210.

Clients 250A and 250B (collectively clients 250) access unified data service 201 through APIs 202. Service discovery 212 keeps track of VI services 52 that are integrated with unified data framework 55. Service discovery 212 manages individual service-related configurations, such as how to connect to each VI service 52. Service discovery 212 obtains configuration and schema from each VI service 52, which is stored in service schema store 222. A client 250 can use schema API 208 to query unified data service 201 for any schema stored in service schema store 222.

Fetch planner 221 is configured to plan a fetch operation given an input schema. A client 250 can fetch a snapshot of object data through snapshot API 204 or stream API 206. Client 250 provides a schema for the fetch operation. Schema validator 220 validates the input schema against schema data stored in service schema 222. Fetch planner 221 determines which VI service 52 or VI services 52 are responsible for the object data specified in the input schema and generates a fetch operation. The fetch operation includes calls to VI service(s) 52 through an API exposed by unified data library 224. Unified data service 201 can receive requests from multiple clients 250 concurrently. Fetch planner 221 can generate fetch operations for multiple VI services 52 in response to such requests. Aggregator 218 is configured to process the fetch operations and make the API calls to VI services 52. That is, aggregator multiplexes the fetch operations across VI services 52. Aggregator 218 also receives fetch responses in response to the API calls to VI services 52. The fetch responses include object data that was targeted by the fetch operations. Aggregator demultiplexes the fetch responses across clients 250 making the fetch requests. Aggregator 218 then returns a response to each respective client 250.

Apply planner 216 is configured to plan an apply operation given a snapshot of object data to be modified. A client 250 can provide a snapshot of object data to be applied through apply API 210. Apply planner 216 determines which VI service 52 or VI services 52 are responsible for the object data to be updated and generates an apply operation. The apply operation includes calls to VI service(s) 52 through an API exposed by unified data library 224. Unified data service 201 can receive requests to apply object data from multiple clients 250 concurrently. Aggregator 218 is configured to process the apply operations and make the API calls to VI services 52. That is, aggregator multiplexes the apply operations across VI services 52. Aggregator 218 also receives apply responses in response to the API calls to VI services 52. The apply responses include success/failure indicators, for example. Aggregator demultiplexes the apply responses across clients 250 making the apply requests. Aggregator 218 then returns a response to each respective client 250.

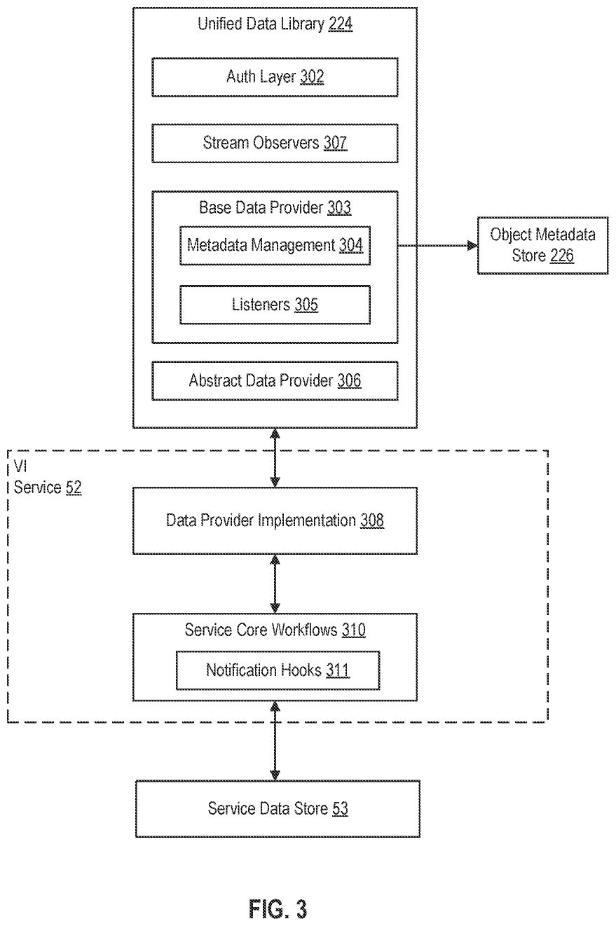

FIG. 3 is a block diagram depicting integration of a unified data library 224 with a VI service 52 according to embodiments. Unified data library 224 includes authentication (auth) logic (“auth layer 302”), stream observer logic (“stream observers 307”), base data provider logic (“base data provider 303”), and an abstract data provider definition (“abstract data provider 306”). Abstract data provider 306 provides an API interface that is implemented by data provider implementation logic (“data provider implementation 308”) in VI service 52. Abstract data provider 306 provides API abstractions such as get, query, add, update, delete, etc. for object data. Data provider implementation 308 provides the implementations for these API abstractions. Base data provider 303 includes logic that can be used by data provider implementation 308 in implementing the APIs. Base data provider 303 includes metadata management logic (“metadata management 304”) that is responsible for storing and update metadata for data objects as discussed further herein. Data provider implementation 308 is responsible for invoking service core workflows 310, which include the logic of VI service 52 for managing the object data (stored in service data store 53).

For example, unified data service 201 can invoke an API specified in abstract data provider 306 to fetch a snapshot of object data (e.g., a get API). Data provider implementation 308 of VI service 52 includes the implementation of the get API, which invokes a service core workflow 310 to read the requested object data from service data store 53. The get API then invokes metadata management 304 to update object metadata (if necessary) and returns the object data to unified data service 201.

In another example, unified data service 201 can invoke an API specified in abstract data provider 306 to apply a snapshot of object data (e.g., an update API). Data provider implementation 308 of VI service 52 includes the implementation of the update API, which invokes a service core workflow 310 to update the object data in service data store 53. The update API invokes metadata management 304 to update object metadata and returns the result of the apply operation.

Auth layer 302 is responsible for obtaining authorization requirements from VI service 52 (e.g., roles, privileges, etc. required to read and write object data). Unified data service 201 (e.g., service discovery 212) invokes auth layer 302 to retrieve the authorization requirements (e.g., during registration of VI service 52). As discussed below, unified data service 201 can first determine if a client is authorized for the fetch or apply operation before sending the operation to VI service 52.

Object metadata stored in object metadata store 226 includes two types of metadata for each data object observed by unified data library 224. The first type of object metadata includes object-related metadata, such as a unique identifier (ID) of the data object and dependency information for the data object (e.g., dependencies on other data object(s)). This object-related metadata is returned by service core workflows 310. The second type of metadata includes unified data framework generated metadata, which can include a modification timestamp for each data object and a checkpoint indicator (“checkpoint”). In embodiments, each data object observed by unified data library 224 includes a row in object metadata store 226. As the data object is updated, the metadata in its corresponding row in object metadata store 226 is updated (e.g., with new timestamp and checkpoint). The object-related metadata is used by unified data framework 55 for ordering and planning related operations. The checkpoint/timestamp related metadata can be used for returning specific sets of object data (that data modified since last checkpoint) and can be used by clients 250 to determine drift in object data from a desired state.

As discussed above, unified data framework 55 supports streaming of updated objected data to clients 250 that subscribe to such updates. In embodiments, this functionality is implemented using notification hooks 311 in service core workflows 310. Notification hooks 311 are triggered when service core workflows 310 update object data in service data store 53 in response to some trigger (e.g., on behalf of user input or another VI service request). Notification hooks 311 trigger calls to listener logic (“listeners 305”) in base data provider 303. Listeners 305 invoke metadata management 304 for updating object metadata and invoke stream observers 307 depending on the object data modified. Each stream observer 307 can monitor a set of data objects and can be instantiated in response to a fetch operation that requests streaming updates for the object data. There can be many stream observers 307 across the same or different clients 250. There can be a listener 305 for each service core workflow 310 having a notification hook 311. Listeners 305 can invoke all stream observers 307, which can ignore the updates if not relevant or callback to unified data service 55 if a relevant update has occurred.

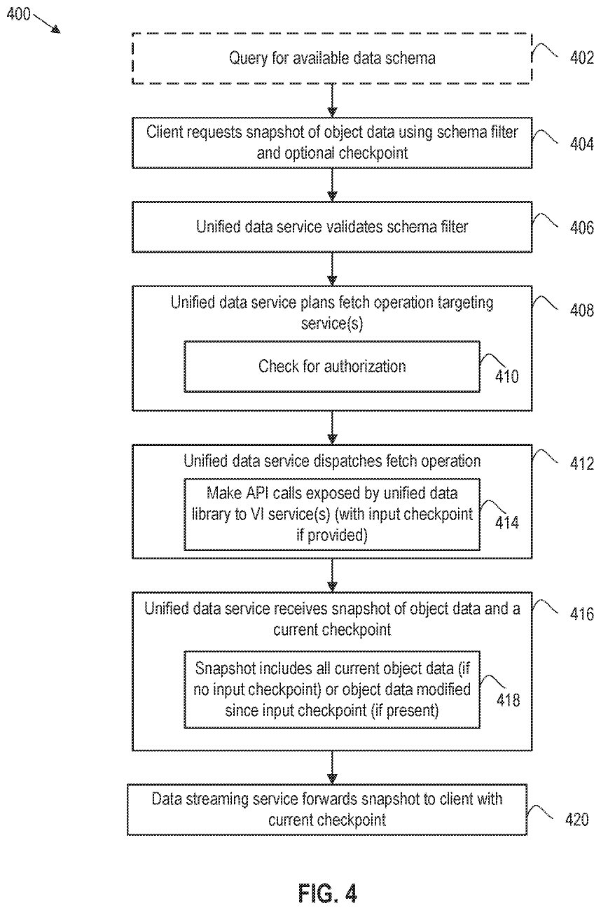

FIG. 4 is a flow diagram depicting a method of fetching a snapshot of object data by a client 250 from unified data framework 55 according to an embodiment. Method 400 begins at step 402, where a client 250 queries unified data service 201 for available data schema. For example, client 250 can query for all data objects related to a specific tag. Step 402 is optional as client 250 may already have knowledge a schema for which client 250 has interest. At step 404, client 250 requests a snapshot of object data using a schema filter (input schema) and an optional checkpoint. At step 406, unified data service 201 validates the input schema. If the requested schema is invalid, unified data service 201 notifies client 250 and rejects the request.

At step 408 (assuming a valid input schema), unified data service 201 plans a fetch operation targeting VI service(s). Fetch planner 221 can operate as described above to generate a fetch operation targeting one or more VI services. Having identified the VI service target(s), fetch planner 221 can check for authorization at step 410. That is, whether client 250 is authorized to fetch object data from the target VI services. If not, unified data service 201 notifies client 250 and rejects the request.

At step 412 (assuming authorization), unified data service 201 dispatches the fetch operation. The dispatch comprises fetch planner 221 in cooperating with aggregator 218 making API calls, exposed by unified data library 224, to target VI service(s) 52 (step 414). If client 250 provided a checkpoint with the fetch request, unified data service 201 also provides the checkpoint with the fetch operation.

At step 416, unified data service 201 receives a snapshot of the object data and a current checkpoint associated therewith as a return of the fetch operation. The snapshot includes all current object data (if no input checkpoint was provided) or object data modified since the input checkpoint (if present) (step 418). At step 420, unified data service 201 forwards the snapshot to client 250 with the current checkpoint.

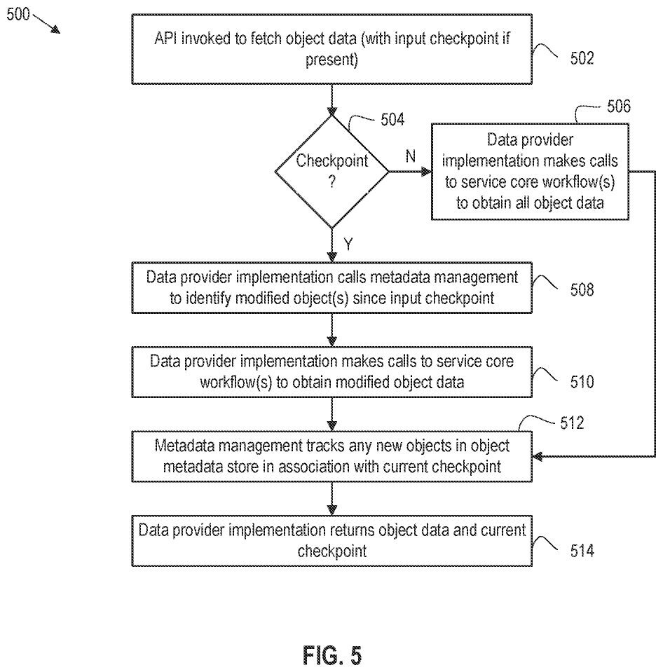

FIG. 5 is a flow diagram depicting a method 500 of handling a fetch operation at a VI service 52 according to an embodiment. Method 500 begins at step 502, where an API specified by unified data library 224 is invoked to fetch object data (with optional checkpoint). Data provider implementation 308 provides the logic of the API. At step 504, data provider implementation 308 determines if a checkpoint is present for the request. If not, method 500 proceeds to step 506, where data provider implementation 308 invokes service core workflow(s) to obtain the object data. If there is a checkpoint in the request, method 500 proceeds to step 508.

At step 508, data provider implementation 308 invokes metadata management 304 to identify modified object(s) since the input checkpoint. At step 510, data provider implementation 308 invokes service core workflow(s) to obtain the object data modified after the checkpoint. At step 512, metadata management 304 tracks any new objects in object metadata store 226 (i.e., any new objects observed) in association with a current checkpoint. At step 514, VI service 52 returns the object data and current checkpoint as a return from the API call exposed by unified data library 224.

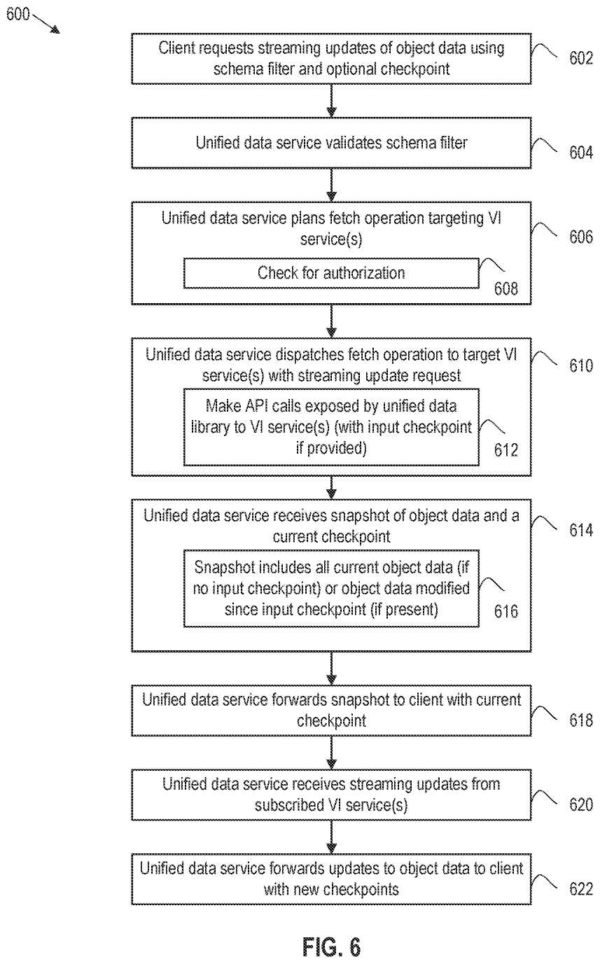

FIG. 6 is a flow diagram depicting a method 600 of subscribing to a stream of data object updates by a client 250 to unified data service 201 according to embodiments. Method 600 begins at step 602, where a client 250 requests unified data service 201 for streaming updates to object data using a schema filter and optional input checkpoint. At step 604, unified data service 201 validates the schema filter. At step 606 (assuming valid input schema), unified data service 201 plans a fetch operation targeting VI service(s). At step 608, unified data service 201 checks of authorization of client 250 in accessing the target VI service(s).

At step 610 (assuming authorization), unified data service 201 dispatches the fetch operation to target VI service(s) with streaming update request. At step 612, unified data service 201 makes API calls to VI service(s) 52 (with input checkpoint if present). At step 614, unified data service 201 receives a snapshot of object data and a current checkpoint as a return to the API call(s). The snapshot includes all current object data (if no input checkpoint was provided) or object data modified since the input checkpoint (if present) (step 616). At step 618, unified data service 201 forwards the snapshot to client 250 with the current checkpoint.

At step 620, unified data service 201 receives streaming updates from subscribed VI service(s) 52 in response to modified object data. At step 622, unified data service 201 forwards updates to object data to client 250 with new checkpoints.

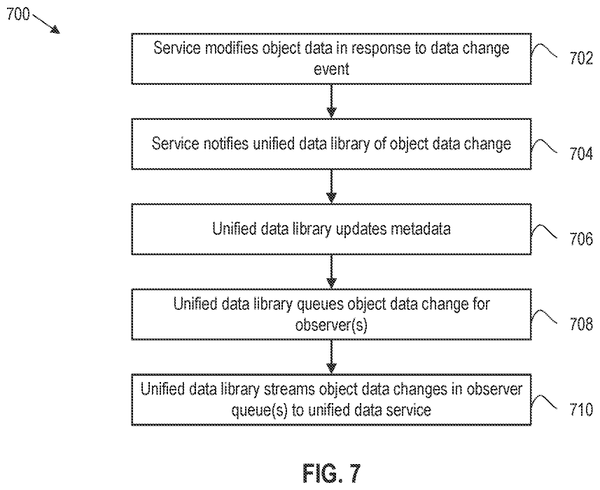

FIG. 7 is a flow diagram depicting a method 700 of handling a streaming request at a VI service 52 according to an embodiment. Method 700 begins at step 702, where VI service 52 modifies object data in response to a data change event (e.g., triggered by a user or another service). At step 704, service core workflow(s) 310 notify unified data library 224 of the object data change. At step 706, unified data library 224 updates object metadata (with new timestamps and checkpoints for modified objects). At step 708, unified data library 224 queues object data changes for observers 307. At step 710, unified data library 224 streams object data changes in observer queue(s) to unified data service 201.

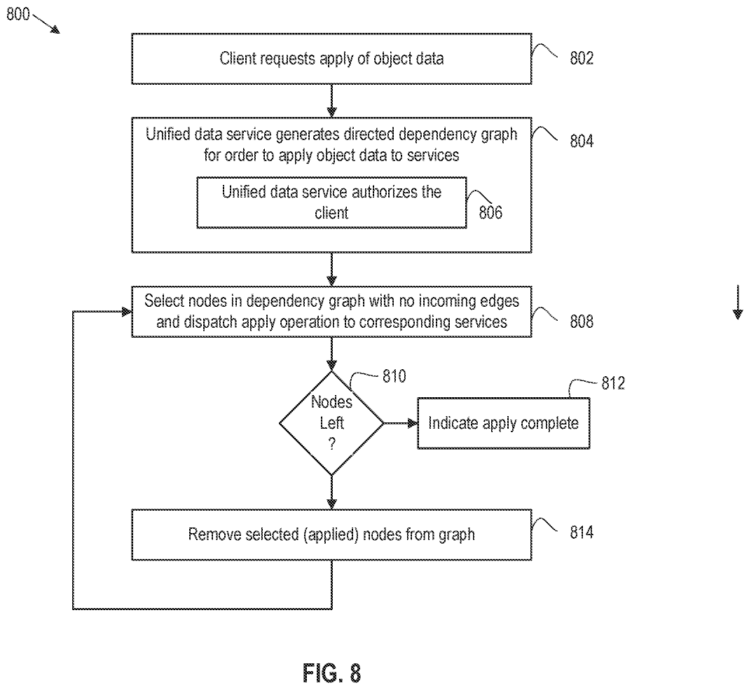

FIG. 8 is a flow diagram depicting a method 800 of applying a snapshot of object data by a client 250 to unified data framework 55 according to an embodiment. Method 800 begins at step 802, where a client 250 requests an apply of object data. At step 804, unified data service 201 generates a directed dependency graph for an order to apply object data to VI services that managed the object data to be updated. At step 806, unified data service 201 checks for authorization of client 250 for target VI service(s).

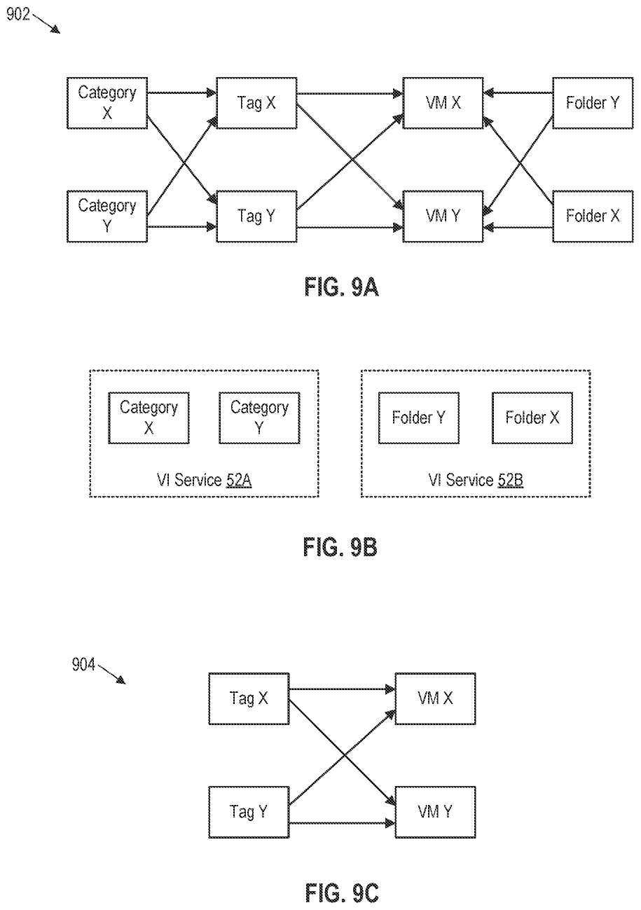

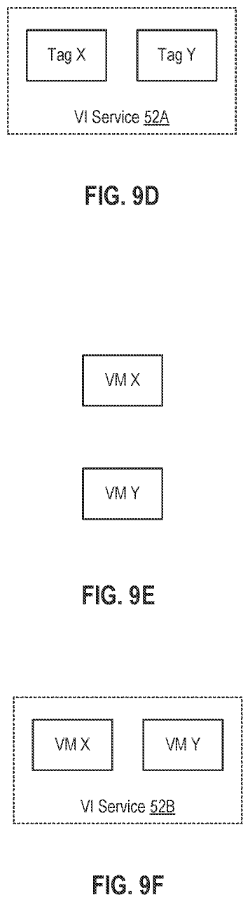

FIG. 9A is a block diagram illustrating an example dependency graph 902 according to embodiments. In the example, a VM X depends on Tag X. Tag Y, Folder X, Folder Y. A VM Y depends on Tag X, Tag Y. Folder X, and Folder Y. The Tag X depends on category X and category Y. The tag Y depends on category X and category Y. Categories X and Y and Folders Y and X have no dependencies.

Returning to FIG. 8, at step 808 (assuming authorization), unified data service 201 selects nodes in the dependency graph with no incoming edges and dispatches an apply operation to VI service(s) 52 managing the data objects associated with those nodes.

FIG. 9B illustrates an operation of selecting nodes in the dependency graph with no incoming edges. As shown in FIG. 9A, those nodes include Category X and Category Y, as well as Folder Y and Folder X. In the example, a VI service 52A is responsible for the data objects associated with Category X and Category Y. A VI service 52B is responsible for the data objects associated with Folder Y and Folder X.

Returning to FIG. 8, at step 810, unified data service 201 determines if there are any nodes left unselected in the dependency graph. If not, method 800 proceeds to step 812, where unified data service 201 indicates the apply operation is complete. Otherwise, method 800 proceeds to step 814. At step 814, unified data service 201 removes the selected nodes from the graph (those nodes that were applied) and returns to step 808.

FIG. 9C illustrates the dependency graph of FIG. 9A after one iteration of the apply operation according to embodiments. In the example, Categories X and Y and Folders X and Y have already been processed and removed from the graph. The remaining portion 904 of the graph includes Tax X, Tag Y, VMx and VM Y. Nodes without incoming edges include Tag X and Tag Y.

FIG. 9D illustrates an operation of selecting nodes in the dependency graph of FIG. 9C with no incoming edges. Tag X and Tag Y have no incoming edges. VI service 52A is responsible for the data objects related to Tag X and Tag Y.

FIG. 9E illustrates the dependency graph of FIG. 9A after two iterations of the apply operation according to embodiments. The graph includes only VM X and VM Y. Nodes without incoming edges include VM X and VM Y.

FIG. 9F illustrates an operation of selecting nodes in the dependency graph of FIG. 9E with no incoming edges. VM X and VM Y had no incoming edges. VI service 52B is responsible for the data objects related to VM X and VM Y.

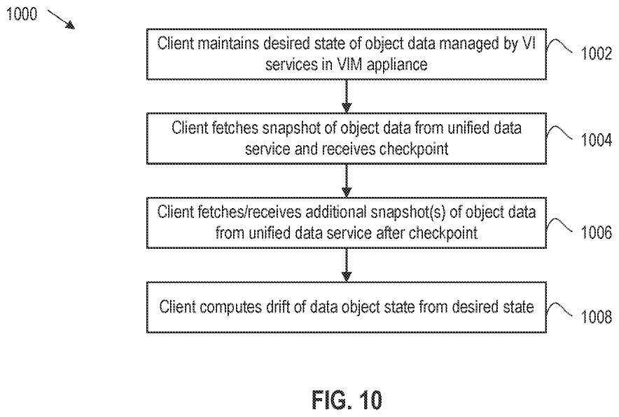

FIG. 10 is a flow diagram depicting a method 1000 of determining drift from a desired state at a client 250 according to an embodiment. Method 1000 begins at step 1002, where client 250 maintains a desired state of object data managed by VI services 52 in a VIM appliance 50. At step 1004, client 250 fetches a snapshot of object data from unified data service 201 in VIM appliance 50. At step 1006, client 250 receives/fetches additional snapshot(s) of the object data from unified data service 201 after a checkpoint associated with the initial snapshot. At step 1008, client 250 computes drift of data object state from the desired state based on the updated object data.

One or more embodiments of the invention also relate to a device or an apparatus for performing these operations. The apparatus may be specially constructed for required purposes, or the apparatus may be a general-purpose computer selectively activated or configured by a computer program stored in the computer. Various general-purpose machines may be used with computer programs written in accordance with the teachings herein, or it may be more convenient to construct a more specialized apparatus to perform the required operations.

The embodiments described herein may be practiced with other computer system configurations including hand-held devices, microprocessor systems, microprocessor-based or programmable consumer electronics, minicomputers, mainframe computers, etc.

One or more embodiments of the present invention may be implemented as one or more computer programs or as one or more computer program modules embodied in computer readable media. The term computer readable medium, or non-transitory computer readable medium, refers to any data storage device that can store data which can thereafter be input to a computer system. Computer readable media may be based on any existing or subsequently developed technology that embodies computer programs in a manner that enables a computer to read the programs. Examples of computer readable media are hard drives, NAS systems, read-only memory (ROM), RAM, compact disks (CDs), digital versatile disks (DVDs), magnetic tapes, and other optical and non-optical data storage devices. A computer readable medium can also be distributed over a network-coupled computer system so that the computer readable code is stored and executed in a distributed fashion.

Certain embodiments as described above involve a hardware abstraction layer on top of a host computer. The hardware abstraction layer allows multiple contexts to share the hardware resource. These contexts can be isolated from each other, each having at least a user application running therein. The hardware abstraction layer thus provides benefits of resource isolation and allocation among the contexts. Virtual machines may be used as an example for the contexts and hypervisors may be used as an example for the hardware abstraction layer. In general, each virtual machine includes a guest operating system in which at least one application runs. It should be noted that, unless otherwise stated, one or more of these embodiments may also apply to other examples of contexts, such as containers. Containers implement operating system-level virtualization, wherein an abstraction layer is provided on top of a kernel of an operating system on a host computer or a kernel of a guest operating system of a VM. The abstraction layer supports multiple containers each including an application and its dependencies. Each container runs as an isolated process in user-space on the underlying operating system and shares the kernel with other containers. The container relies on the kernel's functionality to make use of resource isolation (CPU, memory, block I/O, network, etc.) and separate namespaces and to completely isolate the application's view of the operating environments. By using containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O.

Although one or more embodiments of the present invention have been described in some detail for clarity of understanding, certain changes may be made within the scope of the claims. Accordingly, the described embodiments are to be considered as illustrative and not restrictive, and the scope of the claims is not to be limited to details given herein but may be modified within the scope and equivalents of the claims. In the claims, elements and/or steps do not imply any particular order of operation unless explicitly stated in the claims.

Virtualization systems in accordance with the various embodiments may be implemented as hosted embodiments, non-hosted embodiments, or as embodiments that blur distinctions between the two. Furthermore, various virtualization operations may be wholly or partially implemented in hardware. For example, a hardware implementation may employ a look-up table for modification of storage access requests to secure non-disk data.

Many variations, additions, and improvements are possible, regardless of the degree of virtualization. The virtualization software can therefore include components of a host, console, or guest OS that perform virtualization functions.

Boundaries between components, operations, and data stores are somewhat arbitrary, and particular operations are illustrated in the context of specific illustrative configurations. Other allocations of functionality are envisioned and may fall within the scope of the invention. In general, structures and functionalities presented as separate components in exemplary configurations may be implemented as a combined structure or component. Similarly, structures and functionalities presented as a single component may be implemented as separate components. These and other variations, additions, and improvements may fall within the scope of the appended claims.

What is claimed is:

1. A method of accessing object data managed by virtual infrastructure (VI) services of virtualization management software that manages a cluster of hosts in a data center and a virtualization layer executing in the cluster of hosts, the method comprising:
receiving, from a client at a unified data service executing in the virtualization management software, a request for accessing the object data;
planning, in response to the request, an operation to access the object data that targets a first VI service of the VI services;
invoking, in response to the operation, an application programming interface (API) of the first VI service to access the object data, the API being exposed by a unified data library integrated with the first VI service; and
forwarding, from the unified data service to the client, a result of accessing the object data.

2. The method of claim 1, wherein the request comprises a request for reading the object data, wherein the operation comprises a fetch operation, and wherein the API of the first VI service is configured to fetch a snapshot of the object data.

3. The method of claim 2, wherein the request includes a checkpoint, and wherein the snapshot comprises only the object data modified since the checkpoint.

4. The method of claim 1, wherein the request comprises a request to write the object data, wherein the operation comprises an apply operation, and wherein the API of the first VI service is configured to update a snapshot of the object data stored in a services data store managed by the first VI service.

5. The method of claim 4, wherein the apply operation targets a plurality of the VI services including the first VI service, and wherein the unified data service generates a dependency graph for applying the object data to the plurality of services.

6. The method of claim 1, wherein the request comprises a request for receiving streaming updates from the first VI service, wherein the operation comprises a fetch operation, and wherein the API of the first VI service is configured to fetch a snapshot of the object data and subscribe to receive updates to the object data.

7. The method of claim 6, wherein the VI service is configured to notify the unified data library of updates to the object data, wherein the unified data library queues the updates to the object data, and wherein the result comprises the updates to the object data.

8. A non-transitory computer readable medium comprising instructions to be executed in a computing device to cause the computing device to carry out a method of accessing object data managed by virtual infrastructure (VI) services of virtualization management software that manages a cluster of hosts in a data center and a virtualization layer executing in the cluster of hosts, the method comprising:
receiving, from a client at a unified data service executing in the virtualization management software, a request for accessing the object data;
planning, in response to the request, an operation to access the object data that targets a first VI service of the VI services;
invoking, in response to the operation, an application programming interface (API) of the first VI service to access the object data, the API being exposed by a unified data library integrated with the first VI service; and
forwarding, from the unified data service to the client, a result of accessing the object data.

9. The non-transitory computer readable medium of claim 8, wherein the request comprises a request for reading the object data, wherein the operation comprises a fetch operation, and wherein the API of the first VI service is configured to fetch a snapshot of the object data.

10. The non-transitory computer readable medium of claim 9, wherein the request includes a checkpoint, and wherein the snapshot comprises only the object data modified since the checkpoint.

11. The non-transitory computer readable medium of claim 8, wherein the request comprises a request to write the object data, wherein the operation comprises an apply operation, and wherein the API of the first VI service is configured to update a snapshot of the object data stored in a services data store managed by the first VI service.

12. The non-transitory computer readable medium of claim 11, wherein the apply operation targets a plurality of the VI services including the first VI service, and wherein the unified data service generates a dependency graph for applying the object data to the plurality of services.

13. The non-transitory computer readable medium of claim 8, wherein the request comprises a request for receiving streaming updates from the first VI service, wherein the operation comprises a fetch operation, and wherein the API of the first VI service is configured to fetch a snapshot of the object data and subscribe to receive updates to the object data.

14. The non-transitory computer readable medium of claim 13, wherein the VI service is configured to notify the unified data library of updates to the object data, wherein the unified data library queues the updates to the object data, and wherein the result comprises the updates to the object data.

15. A computing system, comprising:
a cluster of hosts executing a virtualization layer and virtualization management software that manages the cluster of hosts and the virtualization layer, the virtualization management software executing virtual infrastructure (VI) services, the VI services managing object data;
a client in communication with the virtualization management software;
a unified data service executing in the virtualization management software, configured to:
receive, from the client, a request for accessing the object data;
plan, in response to the request, an operation to access the object data that targets a first VI service of the VI services;
invoke, in response to the operation, an application programming interface (API) of the first VI service to access the object data, the API being exposed by a unified data library integrated with the first VI service; and
forward, to the client, a result of accessing the object data.

16. The computing system of claim 15, wherein the request comprises a request for reading the object data, wherein the operation comprises a fetch operation, and wherein the API of the first VI service is configured to fetch a snapshot of the object data.

17. The computing system of claim 15, wherein the request comprises a request to write the object data, wherein the operation comprises an apply operation, and wherein the API of the first VI service is configured to update a snapshot of the object data stored in a services data store managed by the first VI service.

18. The computing system of claim 17, wherein the apply operation targets a plurality of the VI services including the first VI service, and wherein the unified data service generates a dependency graph for applying the object data to the plurality of services.

19. The computing system of claim 15, wherein the request comprises a request for receiving streaming updates from the first VI service, wherein the operation comprises a fetch operation, and wherein the API of the first VI service is configured to fetch a snapshot of the object data and subscribe to receive updates to the object data.

20. The computing system of claim 19, wherein the VI service is configured to notify the unified data library of updates to the object data, wherein the unified data library queues the updates to the object data, and wherein the result comprises the updates to the object data.
